(19) United States
(12) Patent Application Publication
(10) Pub. No.: US 2004/0242427 A1
(43) Pub. Date: Dec. 2, 2004

(54) Cinidon-ethyl containing solid crop protection formulations and corresponding dispersions

(76) Inventors: Sebastian Koltzenburg, Dannstadt-Schauernheim (DE); Wolfgang Schrof, Neuleiningen (DE); Michael Seufert, Bad Durkheim (DE); Robert Heger, Heidelberg (DE); Stephan Lehmann, Ludwigshafen (DE); Uwe Kardorff, Neustadt-Speyerdorf (DE); Cyrill Zagar, Mannheim (DE); Matthias Bratz, Limburgerhof (DE); Eric D. Carlson, Cupertino, CA (US); Han Ting Chang, Livermore, CA (US); Sigrid C. Kuebler, Sunnyvale, CA (US)

Correspondence Address: KEIL & WEINKAUF, 1350 CONNECTICUT AVENUE, N.W., WASHINGTON, DC, 20036, US

(21) Appl. No.: 10/494,703

(22) PCT Filed: Nov. 6, 2002
(86) PCT No.: PCT/EP02/12401

Related U.S. Application Data
(60) Provisional application No. 60/331,057, filed on Nov. 7, 2001.

(51) Int. Cl. A01N 25/10

(52) U.S. Cl. 504/361

(57) ABSTRACT

The invention relates to a solid crop protection formulation comprising

a) cinidon-ethyl as a crop protection agent;

b) at least one random radical copolymer comprising as polymerized units at least one hydrophilic and at least one hydrophobic monomer; and

c) optionally further additives,

wherein at least 50% of the dispersed cinidon-ethyl particles in said solid crop protection formulation are in an X-ray amorphous state and an aqueous dispersion formulation thereof. Additionally, the invention relates to processes for preparing said formulations and the use of said formulations in agriculture. Further, the invention relates to a random radical copolymer essentially consisting of as polymerized units

a) 5 to 95% by weight of styrene as component A;

b) 5 to 95% by weight of DMAPMAM (dimethylaminopropyl methacrylic amide) as component B;

c) 0 to 98% by weight of methyl acrylate and/or vinyl acetate as component C.

The present invention relates to solid crop protection formulations comprising a random radical copolymer and cinidon-ethyl, which is ethyl (Z)-2-chloro-3-[2-chloro-5-(1,3-dioxo-1,3,4,5,6,7-hexahydroisoindol-2-yl)-phenyl]-acrylate, as a crop protection agent, dispersion formulations prepared from said solid crop protection formulations, a process for preparing said solid crop protection formulations and said dispersion formulations, a set of novel random radical copolymers and the use of said crop protection formulations in agriculture.

### BACKGROUND OF THE INVENTION

Crop protection agents are usually administered in form of aqueous systems, because of the availability of said aqueous systems to interact with a biosystem, such as plants, fungi or insects. In the case of crop protection agents which are not soluble in an aqueous enviroment, as well as in the case of those which are only poorly water-soluble, effective administration of the crop protection agent can be difficult due to inadequate bioavailability of the crop protection agent and consequent low activity in crop protection. These solubility problems affect many parameters of administration, for example the method of administration, the rate of administration and the concentration of administration.

It is known that the rate of dissolution of drug particles, such as crop protection agents, can be increased by increasing the surface area of the solid, i.e., decreasing the particle size.

Consequently, methods of making aqueous dispersion formulations containing finely divided drugs have been studied and efforts have been made to control the size range of drug particles in dispersion formulations containing crop protection agents.

Dispersions of particles are generally obtained in two different ways.

Standard grinding processes starting from solid bulk materials do not result in particles with average diameters less than 0.5 μm. Particle size and distribution depend on a variety of parameters like the type of mill or the crushing parts (e.g. silica) used. A further problem is to remove the crushing parts after milling. If smaller grinding fractions are needed, often the smaller crushing parts and grinding dust are left in the product yielding a heterogeneous system. Because of the larger particle size of milled materials it is more difficult to find additives to stabilize a dispersion of these particles against agglomeration, flocculation, sedimentation and flotation.

An alternative is to start from the molecular solution and to form particles by precipitation. This process faces problems from Ostwald ripening (crystal growth) and/or particle agglomeration again resulting in sedimentation and/or flotation. Generally, the precipitation process is induced in a nucleation stage by changing the compatibility with the surrounding medium (solvent system), e.g., by changing or mixing of solvents, changes in pH value, temperature, pressure, or concentration.

In order to stabilize particular systems, surface-active additives have to be used to inhibit crystal growth and agglomeration in a particle size of nanometers. Typical additives are low molecular weight surfactants or oligomers yielding so-called micelles with the drawback of very small content of substrate molecules. Solubilisates show no nucleation process at the beginning of particle formation but a micellar solution process of the substrate by the surfactant molecules. Unfortunately, the solvation power of the surfactants can induce nucleation and crystal growth because of better transportation of substrate molecules through the solvent medium.

High molecular weight additives are e.g. protective colloids, amphiphilic copolymers, thickeners, etc. Whereas protective colloids stabilize particles against agglomeration by coating the particle surfaces forming a repulsive interaction (steric and/or electrostatic) between particles and inhibit growth by blocking growing sites at the particle surface, thickeners stabilize kinetically by slowing down diffusion and particle collision rates.

In any case, these complex interactions in the colloidal state make it nearly impossible to predict an effective additive for a given substrate to stabilize neither from theoretical calculations nor from formulation experience.

WO 97/13503 discloses a method for synthesizing nanoparticles comprising combining an agent and a matrix to form a composite mixture (nanocomposite powder), which can be rehydrated. Said nanoparticles are less than about 5000 nm, preferably less than about 400 nm, more preferably less than about 250 nm. Suitable agents that can be formulated into nanoparticles include pesticide agents among others. The spray drying step involves spray drying different concentrations of the drug dissolved in dimethyl sulfoxide, 1-methyl-2-pyrrolidinone, ethanol or water, with or without surfactants, sugars, and stabilizers. The matrix is formed from a matrix material comprising a carbohydrate, a protein, an inorganic salt, a resin, or a lipid. Said resin is selected from the group consisiting of polyvinyl pyrrolidone, polyvinyl alcohol, polyacrylic acid, polyethylene, polymethacrylate, polyamide, poly[ethylene-vinyl acetate], and shellac. Prefererably the nanoparticles comprise ethyl 3,5-diacetamido-2,4,6-triiodobenzoate as a diagnostic agent or an antiinflammatory agent or an antibiotic agent.

EP-A 0 275 796 discloses a process for the production of colloidal dispergable systems by formation of nanoparticles. The process comprises mixing a first liquid phase of a solution of a compound, for example an biologically active compound in a solvent and optionally a surfactant and a second liquid phase of a non solvent for said compound and optionally a mixing the two liquid phases a colloidal suspension of nanoparticles is obtained. The particle size of said nanoparticles is at most 500 nm.

WO 98/16105 discloses solid nanoparticular formulations for solid crop protection agents, which are suitable for the preparation of liquid formulations with high activities. Said solid formulations, substantially comprising a) one ore more predominantly amorphous crop protection agent(s) with less than 500 mg/l water solubility at 25° C. and b) a coating layer surrounding the constituent (a). Said solid nanoparticular formulations are prepared by mixing a liquid formulation of the crop protection agent with a liquid formulation of the coating layer and subsequently drying the resulting coated crop protection agent. The particle size of the obtained dispersed particles is from 0.05 to 2 μm (50 to 2000 nm). Said coating layer comprises surface active polymeric colloids or surface active oligomeric, amphiphilic compounds or mixtures of both. Preferably biopolymers or modified biopolymers are employed. It is also possible to use synthetic anionic, cationic and neutral polymers, as well as anionic, cationic, non ionic, amphoteric or polymeric surface active compounds. In WO 98/16105 formulations containing cinidon-ethyl are not mentioned.

WO 99/39579 discloses aqueous formulations containing a tetrahydrophthalimide, for example cinidon-ethyl, an anionic tenside, a non-anionic-tenside, a thixotroping additive, and optionally additional herbicidal active substances and additional formulation auxiliary agents, and water.

EP-A 0 875 143 discloses a composition comprising one or more pesticides and one or more oil-soluble polymers, selected from polymers with lipophilic character, and polymers with both lipophilic and hydrophilic character. According to EP-A 0 875 143 the polymer is soluble in organic solvents, vegetable-oils, mineral-oils and/or synthetic oils.

An object of the present invention is to provide solid crop protection formulations comprising a copolymer and cinidon-ethyl as a crop protection agent, wherein the cinidon-ethyl is dispersed in nanoparticular form when said solid crop protection formulation is redispersed in an aqueous medium. Another object of the present invention is to provide copolymers which are suitable to stabilize said nanoparticles of cinidon-ethyl in said redispersed aqueous dispersion formulations.

Cinidon-ethyl, which is ethyl(Z)-2-chloro-3-[2-chloro-5-(1,3-dioxo-1,3,4,5,6,7-hexahydroisoindol-2-yl)-phenyl]-acrylate, is a N-substituted 3,4,5,6-tetrahydrophthalimide, which is known from EP-A 0 240 659. EP-A 0 240 659 discloses N-substituted 3,4,5,6-tetrahydrophthalimides, their preparation and their use as herbicides.

### SUMMARY OF THE INVENTION

The present invention provides novel solid crop protection formulations, aqueous dispersion formulations and formulation conditions able to disperse cinidon-ethyl (crop protecion agent), in a stable nanoparticular form (nanodispersions) in an aqueous medium and novel copolymers which are suitable to stabilize said nanoparticles of cinidon-ethyl in said redispersed aqueous dispersion formulations. Stable particles are defined as particles that do not crystallize, aggregate, flocculate, or precipitate out of the aqueous medium for a period of time depending on the application.

Said novel solid crop protection formulations comprising

a) cinidon-ethyl as a crop protection agent;

b) at least one random radical copolymer comprising as polymerized units at least one hydrophilic and at least one hydrophobic monomer; and

c) optionally further additives,

wherein at least 50% of the dispersed cinidon-ethyl particles in said solid crop protection formulation are in an X-ray amorphous state.

Preferably the random radical copolymer in said novel solid crop protection formulations comprises as polymerized units

a) 5 to 95% by weight of an olefinically unsaturated monomer of the formula (I), as component A,

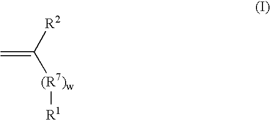

wherein R¹ is selected from the group consisting of alkyl, aryl, alkylaryl or arylalkyl;

R² is H or Me; and

R⁷ is COO, O(CO), C(O)NR², O, N(R²)CO; and

w is 0 or 1;

b) 5 to 95% by weight of one ore more monomers selected from the group consisting of

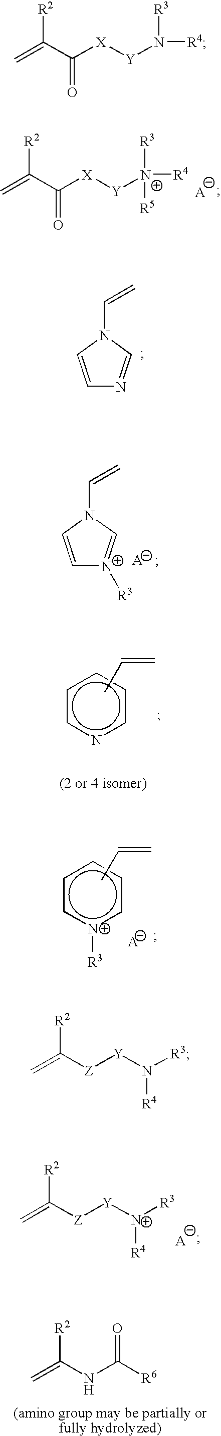

as component B, wherein

R³, R⁴, R⁵ and R⁶ are independently of each other H, aryl, alkyl, arylalkyl, alkylaryl;

Y is an alkylene chain, CₙH₂ₙ, wherein n is 0 to 20;

X and Z are independently of each other O or N(R³);

A− is a monovalent anion or the corresponding stoichiometric amount of a bi- or trivalent anion;

c) 0 to 98% by weight of at least one olefinically unsaturated monomer, as component C.

The average particle size reported in terms of hydrodynamic radius (r_{H}) of the dispersed particles of cinidon-ethyl in said dispersion formulations is from 10-500 nm, preferably from 10-300 nm, more preferably from 10-150 nm. The average particle size may be characterized by light scattering measurements, especially Fiber Optic DLS measurements (FODLS), as described in detail later in the specification.

The solid crop protection formulations are preferably obtained by

a) mixing a solution of at least one random radical copolymer comprising as polymerized units at least one hydrophilic monomer and at least one hydrophobic monomer in at least one first organic solvent and a solution of cinidon-ethyl in at least one second organic solvent which may be the same as or different from said first organic solvent, or dissolving a mixture of at least one random radical copolymer comprising as polymerized units at least one hydrophilic monomer and at least one hydrophobic monomer and cinidon-ethyl in at least one organic solvent, wherein optionally further additives may be added to the organic solvent(s); and

b) removing the organic solvent(s) e.g. by spray drying, vacuum drying, lyophilization or in a fluidized bed dryer.

In another embodiment of the present invention the solid crop protection formulations are obtained by a process comprising the steps of

a) mixing a solution of cinidon-ethyl in at least one organic solvent which is miscible with water and an aqueous solution of at least one random radical copolymer comprising as polymerized units at least one hydrophilic monomer and at least one hydrophobic monomer,

or dissolving a mixture of at least one random radical copolymer comprising as polymerized units at least one hydrophilic monomer and at least one hydrophobic monomer and cinidon-ethyl in at least one organic solvent and mixing the solution obtained with an aqueous system;

or dissolving a mixture of one part of at least one random radical copolymer comprising as polymerized units at least one hydrophilic monomer and at least one hydrophobic monomer and cinidon-ethyl in at least one organic solvent and mixing the solution obtained with water and an aqueous solution of a second part of said at least one random radical copolymer,

wherein optionally further additives may be added to the organic solution and/or the aqueous solution and the mixing is performed by high energy agitation, whereby the crop protection formulation is obtained in form of a dispersion; and

b) removing the water and the organic solvent(s) e.g. by spray drying, vacuum drying, lyophilization or in a fluidized bed dryer.

In the context of the present invention miscible with water has the following meaning. The organic solvents are at least to 10% by weight miscible with water, preferably at least to 15% by weight, more preferably at least to 20% by weight.

The aqueous dispersion formulations which are another subject of the present invention are preferably obtained by dispersing the solid crop protection formulation in an aqueous system.

Another subject of the present invention are novel random radical copolymers which are suitable to stabilize said nanoparticles of cinidon-ethyl in said redispersed aqueous dispersion formulations. Said random radical copolymers essentially consisting of as polymerized units

a) 5 to 95% by weight of styrene as component A;

b) 5 to 95% by weight of DMAPMAM (dimethylaminopropyl methacrylic amide) as component B;

c) 0 to 98% by weight of methyl acrylate and/or vinyl acetate as component C.

The novel solid crop protection formulations and the dispersion formulations are especially useful in agriculture for the control of undesired plant growth.

### DETAILED DESCRIPTION OF THE INVENTION

While solid crop protection formulations and dispersion formulations of crop protection agents which are not soluble in an aqueous enviroment or only poorly water-soluble—like cinidon-ethyl—have been made previously, this work has several novel and unique features. First, the formulations use copolymers of novel composition from a family of random radical copolymers. Second, the dispersion formulations (nanodispersions) formed by redispersing said solid crop protection formulations in an aqueous medium offer very small average particle sizes giving rise to improved stability and high activities.

Properties of cinidon-ethyl as a crop protection agent which are improved by the novel formulations are for example:

The rate of dissolution and the solubility of cinidon-ethyl in aqueous systems;

The reduction of the amounts of cinidon-ethyl for its application in agriculture for good results;

A prolonged persistency of the dispersed cinidon-ethyl.

General Aspects

The following terms which are used in the specification of the present invention have the following general meaning:

Crop Protection Agent

In the context of the present invention the solid crop protection agent—cinidon-ethyl—is the active ingredient, which is poorly soluble in an aqueous system.

Aqueous System

The aqueous system is the application media wherein cinidon-ethyl is formulated and employed in form of a nanoparticular system. The aqueous system may be pure water or water comprising a buffer system, further salts and or further conventional additives. The pH-value of the aqueous system is generally in the range of 2 to 13, preferably 3 to 12, more preferably 4 to 11.

Random Radical Copolymers (Nanodispersants) and Preparation Process

Random Radical Copolymers

The random radical copolymers of the present invention act as nanodispersants. In the context of the present invention nanodispersants are compounds which are compatible with both, cinidon-ethyl, and the application media, which is an aqueous system.

The random radical copolymers employed in the present invention comprise as polymerized units at least one hydrophilic and at least one hydrophobic monomer. Said hydrophilic monomer is preferably a cationic or a basic monomer.

More preferably, said random radical copolymers comprising

a) 5 to 95% by weight, preferably 10 to 70% by weight, more preferably 15 to 55% by weight of an olefinically unsaturated monomer of the formula (I), as component A,

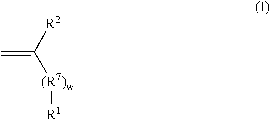

wherein R¹ is selected from the group consisting of alkyl, aryl, alkylaryl or arylalkyl, preferably R¹ is aryl, more preferably phenyl;

R² is H or Me; and

R⁷ is COO, O(CO), C(O)NR², O, N(R²)CO, preferably C(O)NR²; and

w is 0 or 1, preferably w is 0;

b) 5 to 95% by weight, preferably 10 to 70% by weight, more preferably 25 to 65% by weight of one ore more monomers selected from the group consisting of

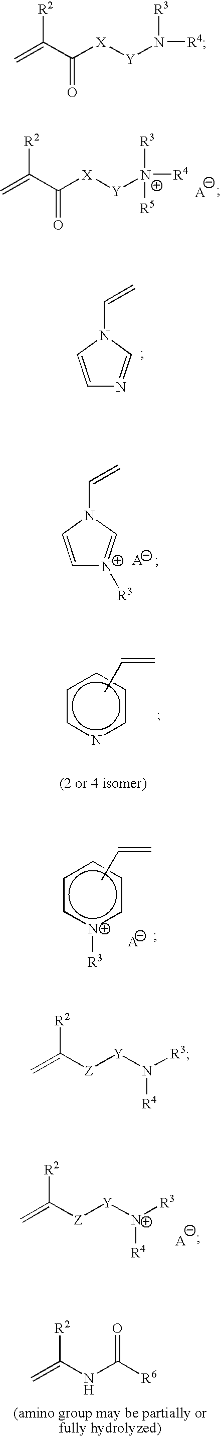

as component B, wherein

R² is H or Me

R³, R⁴, R⁵ and R⁶ are independently of each other H, aryl, alkyl, arylalkyl, alkylaryl, preferably H, C₁- to C₄-alkyl, more preferably ethyl or methyl;

X is O or N(R³), preferably NH;

Y is an alkylene chain, CₙH₂ₙ, wherein n is 0 to 20, preferably 1 to 10, more preferably 2 to 5, most preferably 3;

Z is O or N(R³), preferably O;

A⁻ is a monovalent anion or the corresponding stoichiometric amount of a bi- or trivalent anion, preferably sulfate, methosulfate or chloride;

c) 0 to 98% by weight, preferably 10 to 90% by weight, more preferably 20 to 75% by weight of at least one olefinically unsaturated monomer, as component C.

Component B of the random radical copolymer is preferably at least one monomer selected from the group consisting of

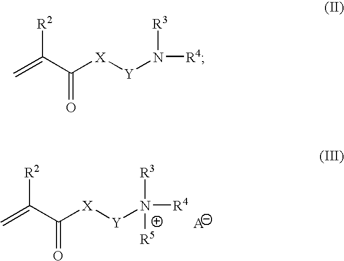

wherein R², R³, R⁴ and R⁵ and X, Y and A⁻ are defined above.

Most preferably component B of the random radical copolymer is DMAPMAM (dimethylaminopropyl methacrylic amide).

Component C is preferably selected from the group of unsaturated ethers, preferably vinyl ethers, for example 1,4-cyclohexane dimethanol divinyl ether, 1,4-cyclohexane dimethanol monovinyl ether, butanediol divinyl ether, butanediol monovinyl ether, cyclohexyl vinyl ether, diethylene glycol divinyl ether, ethylenglycol monovinylether, ethylvinyl ether, methylvinyl ether, n-butylvinyl ether, octadecylvinyl ether, triethylenglycol vinylmethyl ether, vinylisobutyl ether, vinyl-(2-ethylhexyl) ether, vinylpropyl ether, vinylisopropyl ether, vinyldodecyl ether, vinyl-tert.-butyl ether, hexadioldivinyl ether, hexadiolmonovinyl ether, diethyleneglycol monovinyl ether, diethylamino ethylvinyl ether, polytetrahydrofurane-290-divinyl ether, tetraethyleneglycol divinyl ether, ethyleneglycol butylvinyl ether, ethyleneglycol divinyl ether, triethyleneglycol divinyl ether, trimethylolpropane trivinyl ether, aminopropylvinyl ether; acrylates and methacrylates, for example methyl acrylate allyl methacrylate, butanediol dimethacrylate, butanediol monomethacrylate, butyl acrylate, butyl methacrylate, dimethyl aminoethyl acrylate, dimethyl aminoethyl acrylate quarternized with methyl chloride, dimethyl aminoethyl methacrylate, dimethyl aminoethyl methacrylate quarternized with methyl chloride, ethyl acrylate, ethyl diglycol acrylate, ethyleneglycol dimethacrylate, ethylhexyl acrylate, ethyl methacrylate, glycidyl methacrylate, hydroxyethyl methacrylate, hydroxypropyl methacrylate, isobutyl acrylate, isobutyl methacrylate, methyl acrylate, methyl methacrylate, phenoxyethyl acrylate, tert.-butyl acrylate, tert.-butyl methacrylate, triethyleneglycol dimethacrylate, trimethylolpropane trimethacrylate; unsaturated acetates, for example vinyl acetate; alkenes, for example ethylene, 1-butene, 1-decene, 1-hexene, 1-octene, 1-pentene, isobutene, propylene; dienes, for example butadiene, isoprene; unsaturated esters, preferably vinyl esters, for example 4-tert.-butyl benzoic acid vinyl ester, vinyl propionic ester and PEG ester of acrylic acid, PEG ester of methacrylic acid; acrylic amides and methacrylic amides, for example acrylic amide, butoxymethyl methacrylic amide, dimethyl aminopropyl methacrylic amide, methylene bisacrylic amide, tert.-butyl acrylic amide, and N-methyl-N-vinyl acetic amide, vinyl formamide; acrylic acid and methacrylic acid; vinylsulfonic acid; anhydrides, for example maleic anhydride, methacrylic acid anhydride; acrylic nitril and methacrylic nitril; unsaturated aldehydes, for example acrolein; styrene and derivatives, for example α-methyl styrene; and vinyl imidazoles, for example N-vinyl imidazole, 2-methyl-N-vinyl imidazole; N-vinyl caprolactam, N-vinyl pyrrolidone, N-vinyl piperidone, vinyl chloride, vinylidene chloride.

Most preferably a novel random radical copolymer is employed, essentially consisting of

a) 5 to 95% by weight, preferably 20 to 80% by weight, more preferably 30 to 60% by weight of styrene as component A;

b) 5 to 95% by weight, preferably 20 to 80% by weight, more preferably 30 to 60% by weight of DMAPMAM (dimethylaminopropyl methacrylic amide) as component B;

c) 0 to 98% by weight, preferably 0 to 60% by weight, more preferably 0 to 30% by weight of methyl acrylate and/or vinyl acetate as component C.

Preparation of the Random Radical Copolymers

The preparation of said random radical copolymers is preferably carried out in a conventional manner by free radical polymerization, in solution, in mass, in emulsion or in suspension.

The initiator used in the synthesis of said random radical copolymers is a substance capable of forming radicals. Preferably the initiator is selected from the group consisting of azocompounds, for example AIBN (azobisisobutyronitrile), peroxides, for example K₂S₂O₈ and Na₂S₂O₈. Preferably, AIBN is used.

Said initiators are employed in amounts known in the art, for example in amounts of 0.2 to 20% by weight, preferably 1.0 to 10% by weight, relating to the amount of monomers employed.

Suitable solvents are selected from the group consisting of aliphatic carboxylic acids with 1 to 3 carbon atoms, their amides, their mono-C₁-C₄-alkyl amides and di-C₁-C₄ alkyl amides, aliphatic and aromatic chlorohydrocarbons, alcohols of 1 to 5 carbon atoms, for example isopropanol, ketones of 3 to 6 carbon atoms, for example acetone, aromatic hydrocarbons, N-alkylated lactams and mixtures of these. Because of their good solvent power, preferred solvents are methanol, ethanol, isopropanol, formic acid, formamide, dimethylformamide, dimethylpropionamide, N-methylpyrrolidone, methylene chloride, chloroform, 1,2-dichloroethane, chlorobenzene, toluene, xylene, acetone, methylethylketone, methylisopropylketone, methylisobutylketone and mixtures of these.

The composition and conversion in the copolymer synthesis is preferably checked by using standard methods such as NMR (nuclear magnetic resonance) and GPC (gel permeation chromatography).

Nanoparticular Dispersion Formulations

Said random radical copolymers are useful dispersing agents to disperse cinidon-ethyl in form of stable nanoparticular dispersion formulations. Such nanoparticular dispersion formulations are systems comprising at least one continuous phase (dispersion media), which is an aqueous system in the present invention, and at least one dispersed phase. Said dispersed phase (further on called dispersed particles) is in the context of the present invention a solid phase. The dispersion formulations may optionally contain further additives. Suitable examples for said further additives are mentioned below.

Solid Crop Protection Formulation and Preparation Process

Solid Crop Protection Formulation

The solid crop protection formulation of the present invention is especially useful for application in an aqueous media, whereby dispersion formulations with a high activity of the crop protection agent—cinidon-ethyl—are obtained.

Therefore, one embodiment of the present invention is a solid crop protection formulation comprising

a) cinidon-ethyl as a crop protection agent; and

b) at least one random radical copolymer comprising as polymerized units at least one hydrophilic and at least one hydrophobic monomer; and

c) optionally further additives,

wherein at least 50% by weight, preferably 70% by weight and more preferably 90% by weight of the dispersed cinidon-ethyl particles in said solid crop protection formulation are in an X-ray amorphous state. In the context of the present invention X-ray amorphus means the absence of crystal interferences in X-ray powder diagrams.

Random radical copolymers which are preferably employed in the solid crop protection formulations of the present invention are mentioned above.

Furher additives which may optionally be employed in said solid crop protection formulations are mentioned below.

Preparation of Solid Crop Protection Formulations Containing Cinidon-ethyl as a Crop Protection Agent

The solid crop protection formulations may be formed by two different routes:

1. “solid solution route”

2. “precipitation route”

1. “solid solution route”

In one embodiment of the present invention said solid crop protection formulations are formed by a process comprising the steps of

a) mixing a solution of at least one random radical copolymer as mentioned above in at least one first organic solvent and a solution of cinidon-ethyl in at least one second organic solvent which may be the same as or different from said first organic solvent; or dissolving a mixture of at least one random radical copolymer as mentioned above and cinidon-ethyl in at least one organic solvent, wherein optionally further additives (as mentioned above) may be added to the organic solvent(s); and

b) removing the organic solvent(s) e.g. by spray drying, vacuum drying, lyophilization or in a fluidized bed dryer.

In a first step a) of the process an organic solution which comprises at least one of said novel copolymers and cinidon-ethyl as a crop protection agent and optionally further additives in at least one organic solvent is prepared. Said organic solution may be prepared directly by mixing the solutions of one of said novel copolymers and cinidon-ethyl containing optionally further additives or by dissolving a mixture of said random radical copolymer and cinidon-ethyl and optionally further additives in at least one organic solvent.

The total solids content of said organic solution, containing both, said random radical copolymer and cinidon-ethyl, and optionally further additives amounts to 0.5 to 40% by weight, preferably 1 to 20% by weight.

The organic solution of the novel random radical copolymer may be obtained in a conventional manner, if necessary by heating the components in an organic solvent at up to about 150° C. If said random radical copolymers are obtained by solution polymerization, these polymers can be employed in the form of the solution obtained from their preparation.

Suitable organic solvents are preferably selected from the group consisting of alcohols, preferably alcohols of 1 to 5 carbon atoms, for example methanol, ethanol, n-propanol, isopropanol; esters, ketones, preferably ketones of 3 to 6 carbon atoms, for example acetone, methylethylketone, methylisopropylketone, methylisobutylketone; acetates; ethers; preferably cyclic ethers, for example tetrahydrofurane; aliphatic carboxylic acids with 1 to 3 carbon atoms, for example formic acid, their amides, for example formamide, their mono-C₁-C₄-alkylamides, di-C₁-C₄ alkyl amides, for example dimethyl formamide and dimethylpropionamide; aliphatic and aromatic chlorohydrocarbons, for example methylene chloride, chloroform, 1,2-dichloroethane and chlorobenzene; N-alkylated lactams; and mixtures of these.

Because of their good solvent power, preferred solvents are methanol, ethanol, isopropanol, formic acid, formamide, dimethylformamide, dimethylpropionamide, N-methylpyrrolidone, methylene chloride, chloroform, 1,2-dichloroethane, chlorobenzene, acetone, methylethylketone, methylisopropylketone, methylisobutylketone and mixtures of these. The most preferred solvents are methanol, ethanol, n-propanol, isopropanol, acetone, tetrahydrofurane and dimethylformamide.

In a second step b) the organic solvent(s) is/are removed e.g. by spray drying, preferably at a temperature at the spray head of 60 to 180° C., more preferably of 70 to 150° C., vacuum drying, lyophilization or in a fluidized bed dryer to obtain the solid crop protection formulations.

2. “precipitation route”

In another embodiment of the present invention said solid crop protection formulations are formed by a process comprising the step of

mixing a solution of cinidon-ethyl in at least one organic solvent which is miscible with water and an aqueous solution of at least one random radical copolymer as mentioned above,

or dissolving a mixture of at least one random radical copolymer comprising as polymerized units at least one hydrophilic monomer and at least one hydrophobic monomer and cinidon-ethyl in at least one organic solvent and mixing the solution obtained with an aqueous system;

or dissolving a mixture of one part of at least one random radical copolymer comprising as polymerized units at least one hydrophilic monomer and at least one hydrophobic monomer and cinidon-ethyl in at least one organic solvent and mixing the solution obtained with water and an aqueous solution of a second part of said at least one random radical copolymer,

wherein optionally further additives (as mentioned above) may be added to the organic solution and/or the aqueous solution and the mixing is performed by high energy agitation.

This ends up in a formation of a dispersion of the crop protection formulations, comprising particles of cinidon-ethyl as a crop protection agent and at least one copolymer as mentioned above, and optionally further additives.

In the context of the present invention miscible with water has the following meaning. The organic solvents are at least to 10% by weight miscible with water, preferably at least to 15% by weight, more preferably at least to 20% by weight.

In a first step a solution of cinidon-ethyl in a suitable organic solvent is prepared. Suitable organic solvents are solvents which are miscible with water. Said solvents are thermally stable and consist of carbon, hydrogen, oxygen and/or nitrogen. Solvents containing less than 10 carbon atoms and/or having a boiling point below 200° C. are preferred. More preferably said solvents are selected from the group consisting of alcohols, esters, ketones, ethers, di-C₁-C₄ alkyl amides and acetates containing less than 10 carbon atoms and/or having a boiling point below 200° C. Most preferred are ethanol, n-propanol, isopropanol, 2-butandiol-1-methyl ether, 1,2-propanediol-1-n-propyl ether, acetone, dimethyl formamide and tetrahydrofurane.

In one preferred embodiment of the present process the solution of cinidon-ethyl in a suitable organic solvent is obtained at a temperature of 20 to 150° C. in less than 120 s, optionally at a pressure of up to 100 bar, preferably at a pressure of 30 bar.

The obtained solution of cinidon-ethyl preferably comprises 10 to 500 g of cinidon-ethyl in 1000 g of the solvent used.

In a second step said solution of cinidon-ethyl is mixed with an aqueous solution of a random radical copolymer as mentioned above.

It is also possible to add an aqueous solution of the random radical copolymer to the organic solution of cinidon-ethyl.

The concentration of the copolymer in said aqueous solution is preferably from 0.1 to 200 g/l, more preferably from 1 to 100 g/l. Optionally further additives may be added to the organic solution and/or the aqueous solution.

In another embodiment of the present invention a solution of cinidon-ethyl and the random radical copolymer and optionally further additives in a suitable organic solvent as mentioned above is prepared in a first step. In a second step said solution is mixed with an aqueous phase which may additionally comprise a part of the random radical copolymer.

To obtain small particle sizes it is useful to mix the organic solution and the aqueous solution by providing high energy agitation, for example by powerful stirring or shaking in a suitable device. It is also possible to inject one jet of each solution (the organic solution and the aqueous solution) in a mixing chamber, wherein a vigorous mixing occurs.

The mixing may be discontinuous or continuous, which is preferred. This ends up in a formation of a dispersion of the crop protection formulation, comprising particles of cinidon-ethyl as a crop protection agent and at least one copolymer as mentioned above, and optionally further additives.

The dispersion of the crop protection formulation is dried for example by spray drying, vacuum drying, lyophilization or in a fluidized bed dryer to obtain the solid crop protection formulations.

Dispersion Formulations and Preparation Process

The random radical copolymers as mentioned above are especially useful dispersing agents to disperse cinidon-ethyl in a stable nanoparticular form (nanodispersions) in an aqueous medium. This way aqueous dispersion formulations for use in agriculture as crop protection formulations in an aqueous medium are obtained. Said formulations offer very small average particle sizes giving rise to improved stability and high activities.

Therefore, another embodiment of the present invention is a dispersion formulation comprising

a) cinidon-ethyl as a crop protection agent; and

b) at least one random radical copolymer comprising as polymerized units at least one hydrophilic and at least one hydrophobic monomer,

c) optionally further additives; and

d) an aqueous system.

Random radical copolymers which are preferably employed in the dispersion formulations of the present invention are mentioned above. Further additives which may be added to the novel dispersion formulations are also mentioned above.

The ratio of said copolymer to cinidon-ethyl in said dispersion formulations is from 10:1 to 1:10, preferably from 5:1 to 1:5.

An important feature to obtain dispersion formulations with improved stability wherein the particles of the cinidon-ethyl do not crystallize, aggregate, flocculate or precipitate out of the aqueous medium, is the average particle size of cinidon-ethyl in said dispersion formulations. The average particle size, reported in terms of hydrodynamic radius of the dispersed particle in said dispersion formulations is therefore preferably from 10 to 500 nm, more preferably from 10 to 300 nm, most preferably from 10 to 150 nm.

The polydispersity index (PDI value) is preferably from 0.04 to 0.8, more preferably from 0.04 to <0.3.

The average particle sizes and PDI values of particles comprising cinidon-ethyl and the random radical copolymer were characterized by light scattering methods, preferably fiber optic dynamic light scattering measurements (FODLS). Therefore, samples of said dispersion formulations were diluted to approximately 0.005% solids in an appropriate carrier aqueous solution. Average particle sizes and polydispersity indices (PDI values) were determined by second order cumulant analysis and are reported in terms of hydrodynamic radius (r_{H}).

Preparation of Dispersion Formulations Containing Cinidon-ethyl as a Crop Protection Agent in an Aqueous System

The dispersion formulations are obtained by a process comprising the steps of

a) mixing a solution of cinidon-ethyl in at least one organic solvent which is miscible with water and an aqueous solution of at least one random radical copolymer comprising as polymerized units at least one hydrophilic monomer and at least one hydrophobic monomer, wherein optionally further additives may be added to the organic solution and/or the aqueous solution and the mixing is performed by high energy agitation, whereby the crop protection formulation is obtained in form of a dispersion; and

b) removing the organic solvent(s).

Random radical copolymers which are preferably employed in the dispersion formulations of the present invention are mentioned above. Further additives which may be added to the novel dispersion formulations are also mentioned above.

In a preferred embodiment of the present invention the dispersion formulations of cinidon-ethyl were formed by dispersing a solid crop protection formulation as described above of said copolymers and cinidon-ethyl in an aqueous system.

Preferably the aqueous system is added to said solid crop protection formulations and the obtained mixture is preferably agitated to form said dispersion formulations.

Additives in the Crop Protection Formulations of the Present Invention

The crop protection formulations of the present invention may comprise further additives. Suitable additives are known in the art.

Suitable inert auxiliaries are essentially: mineral oil fractions of medium to high boiling point, such as kerosene and diesel oil, furthermore coal tar oils and oils of vegetable or animal origin, aliphatic, cyclic and aromatic hydrocarbons, eg. paraffins, tetrahydronaphthalene, alkylated naphthalenes and their derivatives, alkylated benzenes and their dervatives, alcohols such as mehtanol, ehtanol, propanol, butanol and cyclohexanol, ketones such as cyclohexanone, strongly polar solvents, eg. amines such as N-methylpyrrolidone.

Preferred additives are stabilizers and softeners.

Suitable stabilizers may be low molecular weight compounds, for example mono and diglycerides, esters of mono glycerides, such as acetic ester, citric ester, lactic ester, diacetic tartraic acid ester, alkyl glucosides, sorbitan fatty acid ester, propylene glycol fatty acid ester, stearoyl-2-lactylate, lecithin, fatty acid derivatives of urea and urethanes like dioleyl urea and N-oleyloleyl urethane. Especially preferred are ascorbylpalmitate and fatty acid carbonates like dioleyl carbonate.

The crop protection formulations preferably contain 0 to 90% by weight, more preferably 0 to 50% by weight of said stabilizers.

Softeners are useful to improve the mechanical properties of the novel solid crop protection formulations.

Preferred softeners are sugars or sugar alcohols, for example saccharose, glucose, lactose, fructose, inverted sugar, sorbide, mannitol or glycerol.

The crop protection formulations preferably contain 0 to 90% by weight, more preferably 0 to 50% by weight of said softeners.

Further suitable additives in the aqueous dispersion formulations of the present invention are surfactants.

Suitable surfactants are the alkali metal salts, alkaline earth metal salts and ammoium salts of aromatic sulfonic acids, eg. lignophenol-, naphthalene- and dibutylnaphthalenesulfonic acid, and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene, or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors or methylcellulose.

The aqueous crop protection formulations preferably contain 0 to 90% by weight, more preferably 0 to 50% and most preferably 0,5 to 10% by weight of said surfactants.

Powders, materials for scattering and dusts can be prepared by mixing or grinding the active compounds together with solid carrier.

Granules, eg. coated granules, impregnated granules and homogeneous granules, can be prepared by binding the active compounds to solid carriers. Solid carriers are mineral earths, such as silcas, silica gels, silicates, talc, kaolin, limistone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate and ammonium nitrate, ureas, and products of vegetable origin, such as cereal meal, tree bark meal, wood meal and nutshell meal, cellulose powders, or other solid carriers.

The concentrations of cinidon ehtyl in the aqueous dispersion formulations can be varied within wide ranges. In general, the formulations comprise approximately from 0.001 to 98% by weight, preferably 0.01 to 95% by weight of at least one active compound. The cinidon-ethyl is employed in a purity of from 90% to 100%, preferably 95% to 100% (according to the NMR spectrum).

To widen the spectrum of action and to achieve synergistic effects, the novel crop protection formulations may be mixed with a large number of representatives of other herbicidal or growth-regulating active compound groups and then applied concomitantly. Suitable components for mixtures are, for example, 1,2,4-thiadiazoles, 1,3,4-thiadiazoles, amides, aminophosphoric acid and its derivatives, aminotriazoles, anilides, aryloxy/hetaryloxyalkanoic acids and their derivatives, benzoic acid and its derivatives, benzothiadiazinones, 2-(hetaroyl/aroyl)-1,3-cyclohexanediones, hetaryl aryl ketones, benzylisoxazolidiones, meta-CF₃-phenyl derivatives, carbamates, quinolinecarboxylic acid and its derivatives, chloroacetanilides, cyclohexane-1,3-dione derivatives, diazines, dichloropropionic acid and its derivatives, dihydrobenzofurans, dihydrofuran-3-ones, dinitroanilines, dinitrophenols, diphenyl ethers, dipyridyls, halocarboxylic acids and their derivatives, ureas, 3-phenyluracils, imidazoles, imidazolinones, N-phenyl-3,4,5,6-tetrahydrophthalimides, oxadiazoles, oxiranes, phenols, aryloxy- and hetaryloxyphenoxypropionic esters, phenylacetic acid and its derivatives, 2-phenylpropionic acid and its derivatives, pyrazoles, phenylpyrazoles, pyridazines, pyridinecarboxylic acid and its derivatives, pyrimidyl ethers, sulfonamides, sulfonylureas, triazines, triazinones, triazolinones, triazolecarboxamides and uracils.

It may furthermore be advantageous to apply the compounds I, alone or else concomitantly in combination with other herbicides, in the form of a mixture with other crop protection agents, for example together with agents for controlling pests or phytopathogenic fungi or bacteria. Also of interest is the miscibility with mineral salt solutions, which are employed for treating nutritional and trace element deficiencies. Nonphytotoxic oils and oil concentrates may also be added.

Administration of the Novel Solid Crop Protection Formulations and the Novel Aqueous Dispersion Formulations

The solid crop protection formulations of the present invention can be used for example in the form of ready-to-spray aqueous solutions, powders, suspensions, also highly-concentrated aqueous, oily or other suspensions or dispersions, emulsions, oil dispersions, pastes, dusts, materials for scattering, or granules, by means of spraying, atomizing, dusting, scattering or watering. The use forms depend on the intended applications; in any case, the should ensure a very fine distribution of the active compounds according to the invention.

Preferably, the novel solid crop protection formulations are employed as aqueous dispersions and the aqueous dispersion formulations are formulated as mentioned above. Preferably, the solid crop protection formulations are suspended in an aqueous system at a pH-value as mentioned above and administered to a cultivated plant, its periphery and/or or its seeds without any further additives.

The administration of said aqueous dispersion formulations, which is usually carried out by spraying with a spraying machine, is known in the art.

The novel crop protection formulations or the herbicidal compositions can be applied pre- or post-emergence. If the active compounds are less well tolerated by certain crop plants, application techniques may be used in which the herbicidal compositions are sprayed, with the aid of the spraying equipment, in such a way that they come into as little contact as possible, if any, with the leaves of the sensitive crop plants, while the active compounds reach the leaves of undesirable plants growing underneath, or the bare soil surface (post-directed, lay-by).

The solid crop protection formulations may be delivered to the user (in general a farmer) in a container selected from the group consisting of bottles, cans or bags made of a chemically resistant synthetic material, for example high density polyethylene, polyamide, polyesters etc. Said container may made of a material which is water soluble, for example bags made of a synthetic material comprising polyvinyl alcohol or polyvinyl acetat.

Usually, the solid crop protection formulations of the present invention are redispersed in an aqueous system before use. The redispersion is usually carried out by the farmer.

The rates of application of the crop protection formulation are from 0.001 to 3.0, preferably 0.01 to 1.0, kg/ha of active substance (a.s.), depending on the control target, the season, the target plants and the growth stage.

Use of the Crop Protection Formulations of the Present Invention

The crop protection formulations of the present invention are very useful as herbicides. Further embodiments of the present invention are therefore a process for controlling undesired plant growth comprising the step of administrating a novel solid crop protection formulations or dispersion formulations as decribed above to a cultivated plant, its periphery (living space) and/or its seeds and the use of said novel solid crop protection formulations or dispersion formulations in agriculture.

The crop protection formulations are very useful for controlling undesired plant growth in not cultivated areas. Said crop protection formulations are also very effective against weeds and damaging herbages in populations like wheat, rice, corn, soy, and cotton without damage of the crop. This effect is especially considerable by employing the crop protection formulations in low amounts.

The crop protection formulations of the present invention are also useful for controlling undesired plant growth in other crops like Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinionensis, Citrus limon, Citrus sinensis, Coffea arabica (Coffea canephora, Coffea liberica), Cucumis sativus, Cynodon dactylon, Daucus carota, Elaeis quineensis, Fragaria vesca, Glycine max, Gossypium hirsutum, (Gossypium arboreum, Gossypium herbaceum, Gossypium vitifolium), Heliantus annuus, Hevea brasiliensis, Hordeum vulgare, Humulus lupulus, Iponmoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera, Zea mays.

Additionally, the protection formulations of the present invention are useful in populations which tolerate the effect of herbicides because of breeding including genetic methods.

Moreover, the crop protection formulations of the present invention are also suitable for the desiccation and/or defoliation of plants.

As desiccants, they are suitable, in particular, for desiccating the aerial parts of crop plants such as potatoes, oilseed rape, sunflowers and soybeans. This allows completely mechanical harvesting of these important crop plants.

Also of economic interest is the facilitation of harvesting, which is made possible by dehiscence, or reduction of the adherence to the tree, both concentrated over a period of time, in citrus fruit, olives or other species and varieties of pomaceous fruit, stone fruit and nuts. The same mechanism, i.e. the promotion of the formation of abscission tissue between fruit of leaf and shoot of the plants, is also important for readily controllable defoliation of useful plants, in particular cotton.

Moreover, shortening the period within which the individual cotton plants mature results in improved fiber quality after harvesting.

The examples which follow further illustrate the invention.

### EXAMPLES

Preparation of the Copolymer

### Example 1

### Preparation of the Polymer A

A reaction vessel (1000 ml) fitted with a reflux condenser was charged with 496.15 g of dimethyl formamide (DMF), 2.4 g of azobisisobutyronitrile (AIBN) and 217.95 g of demineralized water and exposed to nitrogen for 30 minutes. A mixture of 20.46 g vinyl acetate, 22.09 g of styrene, 4.35 g of methyl acrylate, and 21.18 g of DMAPMAM (dimethylaminopropyl methacrylic amide) was added. The reaction mixture was heated in an oil bath to 95° C. under stirring. After 18 h at 95° C. the reaction mixture was cooled down to 70° C. and concentrated in vacuo at the rotavap and subsequently dried at 85° C. in vacuo for 96 h. More than 34 g of a slightly colored resin was obtained.

### Example 2

### Preparation of the Polymer B

A reaction vessel (1000 ml) fitted with a reflux condenser was charged with 437.9 g of dimethyl formamide (DMF) and 190.7 g of demineralized water and exposed to nitrogen for 30 minutes. A mixture of 2.1 g of azobisisobutyronitrile (AIBN), 30.11 g of styrene and 39.89 g of DMAPMAM (dimethylaminopropyl methacrylic amide) was added. The reaction mixture was heated in an oil bath to 95° C. under stirring. After 18 h at 95° C. the reaction mixture was cooled down to 70° C. and concentrated in vacuo at the rotavap and subsequently dried at 85° C. in vacuo for 96 h. More than 32 g of a slightly colored resin was obtained.

Preparation of the Solid Crop Protection Formulation and the Aqueous Dispersion Formulation

Average particle sizes (by Fiber Optic DLS measurements)

Average particle sizes were determined in a fiber optic dynamic light scattering apparatus. Samples were diluted to approximately 0.005 wt % solids in the appropriate carrier aqueous solution. Particle sizes and PDI (polydispersity index) values were determined by second order cumulant analysis and are reported in terms of hydrodynamic radius (r_{H}).

### Example 3

a) Solid crop protection formulation by the “solid solution route”

200 g of a copolymer solution of the polymer A (prepared in example 1) in dimethyl formamide (DMF) were mixed with 200 g of a solution (4%-wt) of cinidon-ethyl in dimethyl formamide (DMF). The solution obtained is homogenized and subsequently spray dried to give 18.7 g of a powder formulation.

b) Aqueous dispersion formulation

Said powder (18.7 g) was dispersed in 750 g of an aqueous solution which was buffered to pH 7. A turbid dispersion was obtained. The average particle size was 71 nm (r_{H}).

### Example 4

a) Solid crop protection formulation by the “precipitation route”

A solution of 15 g cinidon-ethyl in 0.5 l of acetone was prepared at 25° C. To precipitate cinidon-ethyl in a nanoparticular form the solution was transfered to a mixing chamber, wherein it was mixed with an aqueous solution (pH 7) of the polymer A (prepared in example 1) and 15 g of lactose. A transparent nanoparticular dispersion of cinidon-ethyl was obtained. The average particle size was 41 nm (r_{H}) with a variance of 31%.

The dispersion was spray dried and a nanoparticular solid crop protection formulation (powder) was obtained. The amount of cinidon-ethyl in said solid crop protection formulation is 24.8% by weight, determined by HPLC (high performance liquid chromatography).

b) Aqueous dispersion formulation

10 g of said powder was dispersed in 50 g of water. A white-turbid dispersion (hydrosol) was obtained. The average particle size was 82 nm (r_{H}) with a variance of 55%.

### Example 5

a) Solid crop protection formulation by the “precipitation route”

A solution of 15 g cinidon-ethyl in 0.5 l of acetone was prepared at 25° C. To precipitate cinidon-ethyl in a nanoparticular form the solution was transfered to a mixing chamber, wherein it was mixed with an aqueous solution (pH 7) of the polymer 2259/31 (prepared in example 1) and 15 g of (NH₄)₂SO₄. A transparent nanoparticular dispersion of cinidon-ethyl was obtained. The average particle size was 46 nm (r_{H}) with a variance of 28%.

The dispersion was spray dried and a nanoparticular solid crop protection formulation (powder) was obtained. The amount of cinidon-ethyl in said solid crop protection formulation is 24.8% by weight, determined by HPLC (high performance liquid chromatography).

b) Aqueous dispersion formulation

Said powder was dispersed in water. A white-turbid dispersion (hydrosol) was obtained. The average particle size was 105 nm (r_{H}) with a variance of 42%.

### Example 6

a) Solid crop protection formulation by the “precipitation route”

A solution of 15 g cinidon-ethyl in 0.5 l of acetone was prepared at 25° C. To precipitate cinidon-ethyl in a nanoparticular form the solution was transfered to a mixing chamber, wherein it was mixed with an aqueous solution (pH 7) of the polymer B (prepared in example 2) and 15 g of lactose. A transparent nanoparticular dispersion of cinidon-ethyl was obtained. The average particle size was 39 nm (r_{H}) with a variance of 32%.

The dispersion was spray dried and a nanoparticular solid crop protection formulation (powder) was obtained. The amount of cinidon-ethyl in said solid crop protection formulation is 24.8% by weight, determined by HPLC (high performance liquid chromatography).

b) Aqueous dispersion formulation

Said powder was dispersed in water. A white-turbid dispersion (hydrosol) was obtained. The average particle size was 96 nm (r_{H}) with a variance of 57%.

Examples of Use

The herbicidal action of the novel crop protection formulations was demonstrated by the following greenhouse experiments:

The culture containers used were plastic flowerpots containing loamy sand with approximately 3.0% of humus as substrate. The seeds of the test plants were sown separately for each species.

For the pre-emergence treatment, solid crop protection formulations, suspended or emulsified in water, were applied directly after sowing by means of finely distributing nozzles. The containers were irrigated gently to promote germination and growth and subsequently covered with transparent plastic hoods until the plants had rooted. This cover caused uniform germination of the test plants unless this was adversely affected by the crop protection agents.

For the post-emergence treatment, the test plants were grown to a plant height of from 3 to 15 cm, depending on the plant habit, and only then treated with the crop protection agents which had been suspended or emulsified in water. To this end, the test plants were either sown directly and grown in the same containers, or they were first grown separately as seedlings and transplanted into the test containers a few days prior to treatment. The rate of application for the post-emergence treatment was 15.63 or 7.81 g/ha a.s. (active substance).

Depending on the species, the plants were kept at from 10 to 25° C. and 20 to 35° C., respectively. The test period extended over 2 to 4 weeks. During this time, the plants were tended, and their response to the individual treatments was evaluated.

Evaluation was carried out using a scale of from 0 to 100. 100 means no emergence of the plants, or complete destruction of at least the aerial parts, and 0 means no damage or normal course of growth.

The plants used in the greenhouse experiments belonged to the following species:

a) catchweed bedstraw (GALAP)

b) wild buckwheat (POLCO)

c) speadwell (VERSS)

In a post-emergence test, the cinidon-ethyl/polymer (solid crop protection formulation of the present invention) shows very good herbicidal activity against the weeds mentioned above as shown in the following table.

| Cinidon- | | | |
|---|---|---|---|
| ethyl/polymer (use | | | |
| rate calculated for | | | |
| pure active | | | |
| ingredient) | GALAP | POLCO | VERSS |
| 15.63 g/ha | 100 | 100 | 100 |
| active ingredient | | | |
| 7.81 g/ha | 100 | 100 | 100 |
| active ingredient | | | |

Desiccation and Defoliation

The test plants used were young cotton plants with 4 leaves (without cotyledons) which had been grown under greenhouse conditions (relative atmospheric humidity: 50 to 70%; day/night temperature 27/20° C.).

The young cotton plants were subjected to foliar treatment to runoff point with aqueous preparations of the solid crop protection formulation with an addition of 0.15% by weight of the fatty alcohol alkoxide Plurafac LF 700, based on the spray mixture). The amount of water applied was 1000 l/ha (converted).

No leaves were shed in the untreated control plants.

1. A solid crop protection formulation comprising
a) cinidon-ethyl as a crop protection agent;
b) at least one random radical copolymer comprising as polymerized units at least one hydrophilic and at least one hydrophobic monomer; and
c) optionally further additives,
wherein at least 50% of the dispersed cinidon-ethyl particles in said solid crop protection formulation are in an X-ray amorphous state.

2. The solid crop protection formulation as claimed in claim 1, wherein the hydrophilic monomer of said random radical copolymer is a cationic or a basic monomer.

3. The solid crop protection formulation as claimed in claim 1 or 2, wherein the random radical copolymer comprises as polymerized units
a) 5 to 95% by weight of an olefinically unsaturated monomer of the formula (I), as component A, 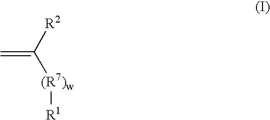
wherein R¹ is selected from the group consisting of alkyl, aryl, alkylaryl or arylalkyl;
R² is H or Me; and
R⁷ is COO, O(CO), C(O)NR², O, N(R²)CO; and
w is 0 or 1;
b) 5 to 95% by weight of one ore more monomers selected from the group consisting of 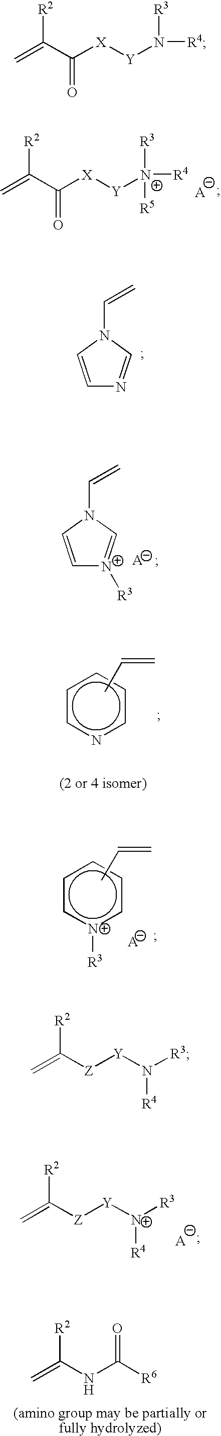
as component B, wherein
R³, R⁴, R⁵ and R⁶ are independently of each other H, aryl, alkyl, arylalkyl, alkylaryl;
Y is an alkylene chain, CₙH₂ₙ, wherein n is 0 to 20;
X, Z are O or N(R³);
A⁻ is a monovalent anion or the corresponding stoichiometric amount of a bi- or trivalent anion;
c) 0 to 98% by weight of at least one olefinically unsaturated monomer, as component C.

4. The solid crop protection formulation as claimed in claim 3, wherein component B of the random radical copolymer is at least one monomer selected from the group consisting of 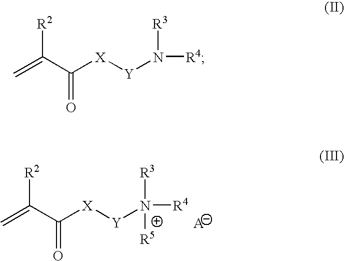
wherein R², R³, R⁴ and R⁵ are independently of each other H, aryl, alkyl, arylalkyl, alkylaryl;
Y is an alkylene chain, CₙH₂ₙ, wherein n is 0 to 20;
X is O or N(R³); and
A⁻ is a monovalent anion or the corresponding stoichiometric amount of a bi- or trivalent anion.

5. The solid crop protection formulation as claimed in claim 4, wherein the random radical copolymer essentially consisting of
a) 5 to 95% by weight of styrene as component A;
b) 5 to 95% by weight of DMAPMAM (dimethylaminopropyl methacrylic amide) as component B;
c) 0 to 98% by weight of methyl acrylate and/or vinyl acetate as component C.

6. A dispersion formulation comprising
a) cinidon-ethyl as a crop protection agent, and
b) at least one random radical copolymer comprising as polymerized units at least one hydrophilic and at least one hydrophobic monomer,
c) optionally further additives, and
d) an aqueous system.

7. The dispersion formulation as claimed in claim 6, wherein the average particle size in terms of hydrodynamic radius of said dispersed cinidon-ethyl particles in said dispersion formulation is from 10 to 500 nm.

8. The dispersion formulation as claimed in claim 6 or 7, wherein the polydispersity index of said dispersed cinidon-ethyl particles in said dispersion formulation is from 0.04 to 0.8.

9. The dispersion formulation as claimed in any of claims 6 to 8, wherein the ratio of said copolymer to cinidon-ethyl is from 10:1 to 1:10.

10. A process for preparing a solid crop protection formulation as claimed in any of claims 1 to 5, comprising the steps of
a) mixing a solution of at least one random radical copolymer comprising as polymerized units at least one hydrophilic and at least one hydrophobic monomer in at least one first organic solvent and a solution of cinidon-ethyl in at least one second organic solvent which may be the same as or different from said first organic solvent; or dissolving a mixture of at least one random radical copolymer comprising as polymerized units at least one hydrophilic and at least one hydrophobic monomer and cinidon-ethyl in at least one organic solvent; wherein optionally further additives may be added to the organic solvent(s); and
b) removing the organic solvent(s) e.g. by spray drying, vacuum drying, lyophilization or in a fluidized bed dryer.

11. A process for preparing a solid crop protection formulation as claimed in any of claims 1 to 5, comprising the steps of
a) mixing a solution of cinidon-ethyl in at least one organic solvent which is miscible with water and an aqueous solution of at least one random radical copolymer comprising as polymerized units at least one hydrophilic monomer and at least one hydrophobic monomer, wherein optionally further additives may be added to the organic solution and/or to the aqueous solution and the mixing is performed by high energy agitation, whereby the crop protection formulation is obtained in form of a dispersion; and
b) removing the water and the organic solvent(s) e.g. by spray drying, vacuum drying, lyophilization or in a fluidized bed dryer.

12. A process for preparing a dispersion formulation as claimed in any of claims 6 to 9, comprising the steps of
a) mixing a solution of cinidon-ethyl in at least one organic solvent which is miscible with water and an aqueous solution of at least one random radical copolymer comprising as polymerized units at least one hydrophilic monomer and at least one hydrophobic monomer, wherein optionally further additives may be added to the organic solution and/or to the aqueous solution and the mixing is performed by high energy agitation, whereby the crop protection formulation is obtained in form of a dispersion; and
b) removing the organic solvent(s).

13. A process for preparing a dispersion formulation as claimed in any of claims 6 to 9, comprising the step of dispersing the solid crop protection formulation as claimed in any of claims 1 to 5 in an aqueous system.

14. Random radical copolymer essentially consisting of as polymerized units
a) 5 to 95% by weight of styrene as component A;
b) 5 to 95% by weight of DMAPMAM (dimethylaminopropyl methacrylic amide) as component B;
c) 0 to 98% by weight of methyl acrylate and/or vinyl acetate as component C.

15. A process for controlling undesired plant growth comprising the step of administrating the novel solid crop protection formulation as claimed in any of claims 1 to 5 to a cultivated plant, its periphery (living space) and/or its seeds.

16. A process for controlling undesired plant growth comprising the step of administrating the novel dispersion formulation as claimed in any of claims 6 to 9 to a cultivated plant, its periphery (living space) and/or its seeds.

17. Use of the crop protection formulations as claimed in any of claims 1 to 5 as herbicides.
